(19) United States
(12) Patent Application Publication
(10) Pub. No.: US 2011/0310809 A1
(43) Pub. Date: Dec. 22, 2011

(54) Wireless Communication Base Station Apparatus and Channel Allocation Method

(75) Inventors: Akihiko Nishio, Kanagawa (JP); Daichi Imamura, Kanagawa (JP); Seigo Nakao, Kanagawa (JP)

(73) Assignee: Panasonic Corporation, Osaka (JP)

(21) Appl. No.: 12/673,043

(22) PCT Filed: Aug. 12, 2008
(86) PCT No.: PCT/JP2008/002198

§ 371 Date: Feb. 11, 2010

(30) Foreign Application Priority Data
Aug. 13, 2007 (JP) 2007-211103
Nov. 1, 2007 (JP) 2007-285601

(51) Int. Cl. H04W 72/04

(52) U.S. Cl. 370/329

(57) ABSTRACT

A wireless communication base station apparatus by which data transmission efficiency can be improved. In the apparatus, a PDCCH allocation unit (101) allocates inputted uplink allocation information (#1 to #K) to PDCCHs from PDCCH #1 to PDCCH #K, an ACK/NACK channel allocation unit (105) allocates a response signal to be sent to each mobile station to the ACK/NACK channel that is associated with the CCE whose CCE number is the largest among the CCEs that constitute the PDCCH to which the uplink allocation information on the mobile station is allocated, and an arrangement unit (106) arranges the ACK/NACK channel to which the response signal is allocated to the downlink resource ensured for the ACK/NACK channel.

### TECHNICAL FIELD

The present invention relates to a radio communication base station apparatus and channel allocating method.

### BACKGROUND ART

In mobile communication, ARQ (Automatic Repeat reQuest) is applied to uplink data transmitted from a radio communication mobile station apparatus (hereinafter abbreviated to a “mobile station”) to a radio communication base station apparatus (hereinafter abbreviated to a “base station”) in uplink, and a response signal representing an error detection result of uplink data is fed back to the mobile station in downlink. The base station performs a CRC (Cyclic Redundancy Check) detection of uplink data, and, if CRC=OK (no error), feeds back an ACK (ACKnowledgement) signal, or, if CRC=NG (error present), feeds back a NACK (Negative ACKnowledgement) signal, as a response signal to the mobile station.

Here, studies are underway to apply synchronization HARQ (Hybrid ARQ) to uplink data. With synchronization HARQ, the base station feeds back a response signal to the mobile station a predetermined time after receiving uplink data, and, if the base station feeds back a NACK signal, the mobile station retransmits uplink data to the base station a predetermined time after receiving the NACK signal.

Also, the base station transmits control information to indicate a resource allocation result in uplink data, to the mobile station. This control information is transmitted to the mobile station using downlink control channels such as a PDCCH (Physical Downlink Control Channel). A PDCCH is comprised of physical resource units called “CCE's (Control Channel Elements),” and each PDCCH occupies one or a plurality of CCE's. The base station forms PDCCH's based on the number of CCE's required to indicate control information, allocates control information to physical resources associated with CCE's occupied by the PDCCH's, and transmits the result.

On the other hand, for an efficient use of downlink communication resources in synchronization HARQ, studies are underway to associate ACK/NACK channels to transmit downlink response signals with the CCE's comprising PDCCH's to allocate uplink resources to mobile stations (e.g. see Non-Patent Document 1). By this means, even if allocation information of ACK/NACK channels is not indicated separately, mobile stations can decide ACK/NACK channels for those mobile stations according to PDCCH's from the base station. Here, in the prior art, when a PDCCH is comprised of a plurality of CCE's, an ACK/NACK channel associated with the CCE of the lowest CCE number is used.

Also, if synchronization HARQ is applied to uplink data, the data transmission timing is set in advance, and, consequently, a PDCCH for resource allocation for uplink data upon a second or subsequent transmission (i.e. retransmission) is not transmitted to a mobile station that transmits uplink data upon a second or subsequent transmission (i.e. retransmission) to a base station. Also, a response signal to the uplink data upon a second or subsequent transmission (retransmission) is transmitted using the same ACK/NACK channel as an ACK/NACK channel used upon the first transmission (i.e. initial transmission). Non-Patent Document 1: 3GPP RAN WG1 Meeting document, R1-073106, “LTE downlink ACK Channel mapping linked to CCE”, Samsung, June 2007

### DISCLOSURE OF INVENTION

### Problems to be Solved by the Invention

According to the above prior art, a base station forms a PDCCH such that, upon transmitting the PDCCH to which control information for another mobile station is allocated, a response signal to uplink data allocated by the PDCCH and a response signal to uplink data upon a second or subsequent transmission (retransmission) do not collide. Also, by comprising a PDCCH with a CCE, which is associated with an ACK/NACK channel to which a response signal to uplink data upon a second or subsequent transmission (retransmission) is allocated, and a plurality of CCE's including a CCE of a lower number than that CCE, a base station can use the CCE associated with the ACK/NACK channel to which the response signal to the uplink data upon a second or subsequent transmission (retransmission) is allocated.

For example, if twelve CCE's #1 to #12 are used, a response signal to uplink data allocated by PDCCH #5 comprised of CCE #5 is allocated to ACK/NACK channel CH #5 associated with CCE #5. Here, if a second transmission (i.e. the first retransmission) of the uplink data allocated by PDCCH #5 is necessary, the base station uses PDCCH #4 comprised of CCE #4 and CCE #5, as the PDCCH to which control information for another mobile station is allocated. By this means, a response signal to uplink data allocated by PDCCH #4 is allocated to ACK/NACK channel CH #4 associated with CCE #4. Therefore, even if CCE #5 is used in PDCCH #4, collision does not occur in ACK/NACK channel CH #5 to which a response signal to uplink data allocated by PDCCH #5 is allocated.

Here, when PDCCH #1 is comprised of CCE #1 of the lowest CCE number, a response signal to uplink data allocated by that PDCCH is allocated to ACK/NACK channel. CH #1 associated with CCE #1. Further, if a second transmission (first retransmission) of the uplink data allocated by a PDCCH is necessary, a response signal to the uplink data is also allocated to ACK/NACK channel CH #1. In this case, if a PDCCH to which control information for another mobile station is allocated includes CCE #1, collision occurs in ACK/NACK channel CH #1, and, consequently, a base station cannot use CCE #1. That is, during the time ACK/NACK channel CH #1 is allocated to a mobile station that transmits uplink data upon a second or subsequent transmission (retransmission), a state occurs where CCE #1 cannot be newly used, and, consequently, communication resources are wasted. Therefore, data transmission efficiency degrades.

It is therefore an object of the present invention to provide a base station and channel allocating method for improving data transmission efficiency.

### MEANS FOR SOLVING THE PROBLEM

The base station of the present invention employs a configuration having: a first allocating section that allocates resource allocation information of uplink data to a first control channel comprised of one or a plurality of control channel elements; and a second allocating section that, upon an initial transmission or a second transmission of the uplink data, allocates a response signal to the uplink data to a second control channel associated with a control channel element different from a control channel element of a lowest control channel element number among the plurality of control channel elements.

### ADVANTAGEOUS EFFECT OF THE INVENTION

According to the present invention, it is possible to improve data transmission efficiency.

### BRIEF DESCRIPTION OF DRAWINGS

FIG. 1 is a block diagram showing the configuration of a base station according to Embodiment 1 of the present invention;

FIG. 2 shows associations between CCE's and ACK/NACK channels according to Embodiment 1 of the present invention;

FIG. 3 shows associations between CCE's and ACK/NACK channels according to Embodiment 2 of the present invention;

FIG. 4 is a diagram showing mirror-image relationships between CCE numbers of CCE's and channel numbers of ACK/NACK channels;

FIG. 5 shows associations between CCE's and ACK/NACK channels according to Embodiment 3 of the present invention (in the case of mirror-image relationship);

FIG. 6 shows associations between CCE's and ACK/NACK channels according to Embodiment 3 of the present invention (in the case of cyclic shift);

FIG. 7 shows HARQ frames according to Embodiment 4 of the present invention;

FIG. 8 shows associations between CCE's and ACK/NACK channels according to Embodiment 4 of the present invention;

FIG. 9 shows associations between CCE's and ACK/NACK channels according to Embodiment 5 of the present invention (in the case where an HARQ frame number is an odd number); and

FIG. 10 shows associations between CCE's and ACK/NACK channels according to Embodiment 5 of the present invention (in the case where an HARQ frame number is an even number).

### BEST MODE FOR CARRYING OUT THE INVENTION

Embodiments of the present invention will be explained below in detail with reference to the accompanying drawings.

### Embodiment 1

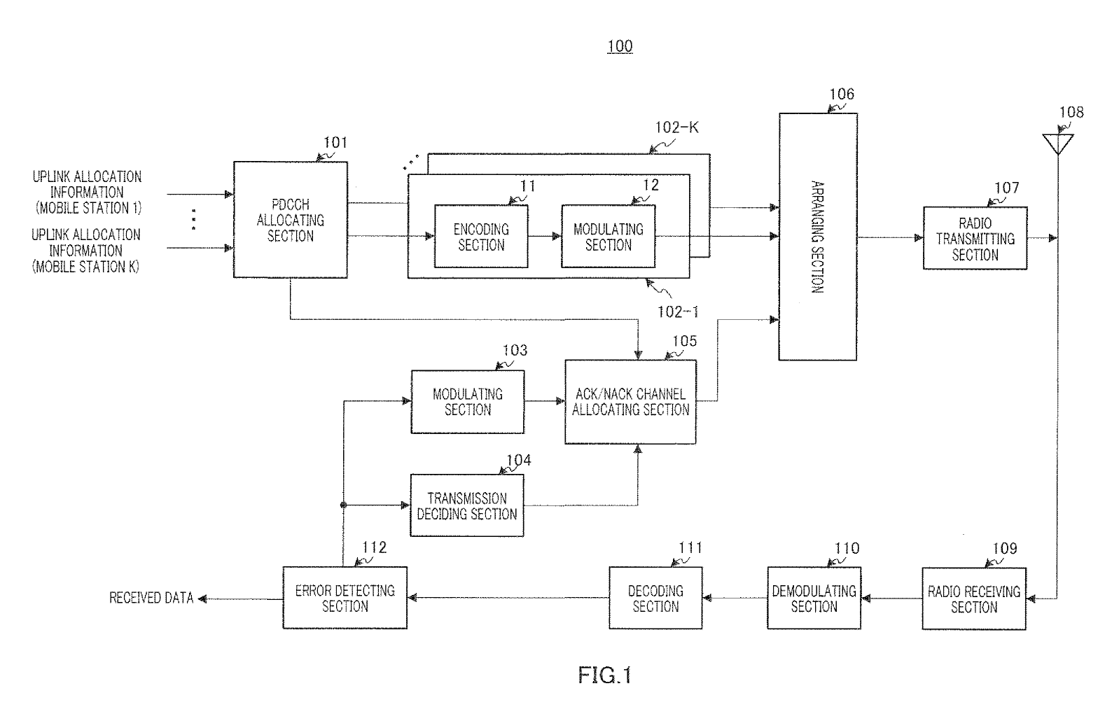

FIG. 1 shows the configuration of base station 100 according to the present embodiment.

Here, to avoid complicated explanation, FIG. 1 shows components relating to downlink transmission of uplink allocation information, components relating to downlink transmission of a response signal to uplink data and components relating to reception of uplink data, which are closely related to the present invention, and the illustration and explanation of the components associated with downlink data transmission will be omitted.

In base station 100 shown in FIG. 1, PDCCH allocating section 101 receives as input uplink allocation information #1 to #K indicating which uplink resource is allocated to which mobile station among maximum K mobile stations #1 to #K. PDCCH allocating section 101 allocates uplink allocation information #1 to #K received as input, to PDCCH's #1 to #K. Also, each PDCCH is comprised of one or a plurality of CCE's among CCE's #1 to #M. PDCCH allocating section 101 outputs uplink allocation information #1 to #K to encoding and modulating section 102-1 to 102-K associated with PDCCH's to which uplink allocation information #1 to #K are allocated. Further, PDCCH allocating section 101 outputs, to ACK/NACK channel allocating section 105, CCE allocation information indicating which mobile station's uplink allocation information is allocated to which CCE,

Encoding and modulating sections 102-1 to 102-K are provided in association with PDCCH's #1 to #K. In encoding and modulating sections 102-1 to 102-K, encoding sections 11 encode uplink allocation information received as input, and output the results to modulating sections 12. Next, modulating sections 12 generate uplink allocation information symbols by modulating the encoded uplink allocation information received as input from encoding sections 11, and output the results to arranging section 106.

Modulating section 103 modulates the response signal of each mobile station received as input from error detecting section 112. Modulating section 103 then outputs the modulated response signals to ACK/NACK channel allocating section 105.

Transmission deciding section 104 counts the number of uplink data transmissions on a per mobile station basis, based on the response signal for each mobile station received as input from error detecting section 112, and decides whether the uplink data of each mobile station is subjected to the first transmission (initial transmission) or the uplink data of each mobile station is subjected to a second or subsequent transmission (retransmission). Further, transmission deciding section 104 outputs the decision result indicating the initial transmission or a retransmission, to ACK/NACK channel allocating section 105.

ACK/NACK channel allocating section 105 allocates response signals received as input from modulating section 103, to ACK/NACK channels based on CCE allocation information received as input from PDCCH allocating section 101 and the decision result received as input from transmission deciding section 104. To be more specific, if a decision result from transmission deciding section 104 indicates the initial transmission, ACK/NACK channel allocating section 105 allocates the response signal for each mobile station to ACK/NACK channels associated with the CCE's comprising PDCCH's to which the uplink allocation information for each mobile station is allocated. Here, if a plurality of CCE's comprise a PDCCH, ACK/NACK channel allocating section 105 allocates a response signal to the ACK/NACK channel associated with the CCE of the highest CCE number among the plurality of CCE's comprising the PDCCH. By contrast, if a decision result from transmission deciding section 104 indicates a retransmission, ACK/NACK channel allocating section 105 allocates the response signal of each mobile station to the same ACK/NACK channel as the ACK/NACK channel used in the first transmission (initial transmission). Further, ACK/NACK channel allocating section 105 outputs the response signals allocated to the ACK/NACK channels, to arranging section 106. The ACK/NACK channel allocation process in ACK/NACK channel allocating section 105 will be described later in detail.

Arranging section 106 arranges the PDCCH's, to which uplink allocation information symbols are allocated, in downlink resources reserved for PDCCH's, and arranges ACK/NACK channels, to which response signals are allocated, in downlink resources reserved for ACK/NACK channels. Further, arranging section 106 outputs signals, in which the channels have been arranged, to radio transmitting section 107.

Radio transmitting section 107 performs transmission processing such as D/A conversion, amplification and up-conversion on the signals received as input from arranging section 106, and transmits the results to mobile stations via antenna 108.

On the other hand, radio receiving section 109 receives the uplink data transmitted from each mobile station via antenna 108, and performs reception processing such as down-conversion and A/D conversion on that uplink data.

Demodulating section 110 demodulates uplink data and outputs the demodulated uplink data to decoding section 111.

Decoding section 111 decodes the demodulated uplink data and outputs the decoded uplink data to error detecting section 112.

Error detecting section 112 performs error detection using CRC detection of the decoded uplink data, and generates an ACK signal if CRC=OK (no error) or generates a NACK signal if CRC=NG (error present), and outputs the generated response signal to modulating section 103 and transmission deciding section 104. Here, if CRC=OK (no error), error detecting section 112 outputs the decoded uplink data as received data.

On the other hand, upon receiving the PDCCH for each subject mobile station from a base station, each mobile station transmits transmission data to the base station based on uplink allocation information and MCS (Modulation and Coding Scheme). Further, each mobile station receives a response signal allocated to an ACK/NACK channel associated with a CCE comprising the PDCCH allocated to each subject mobile station. Here, in each mobile station, it is designated by a higher layer or determined in advance which ACK/NACK channel is associated with which downlink resource. Further, if a response signal is an ACK signal, for transmitting the next transmission data, each mobile station waits until the PDCCH for each subject mobile station is transmitted from the base station. By contrast, if the response signal is a NACK signal, each mobile station retransmits transmission data.

Next, the ACK/NACK channel allocation process in ACK/NACK channel allocating section 105 will be explained in detail.

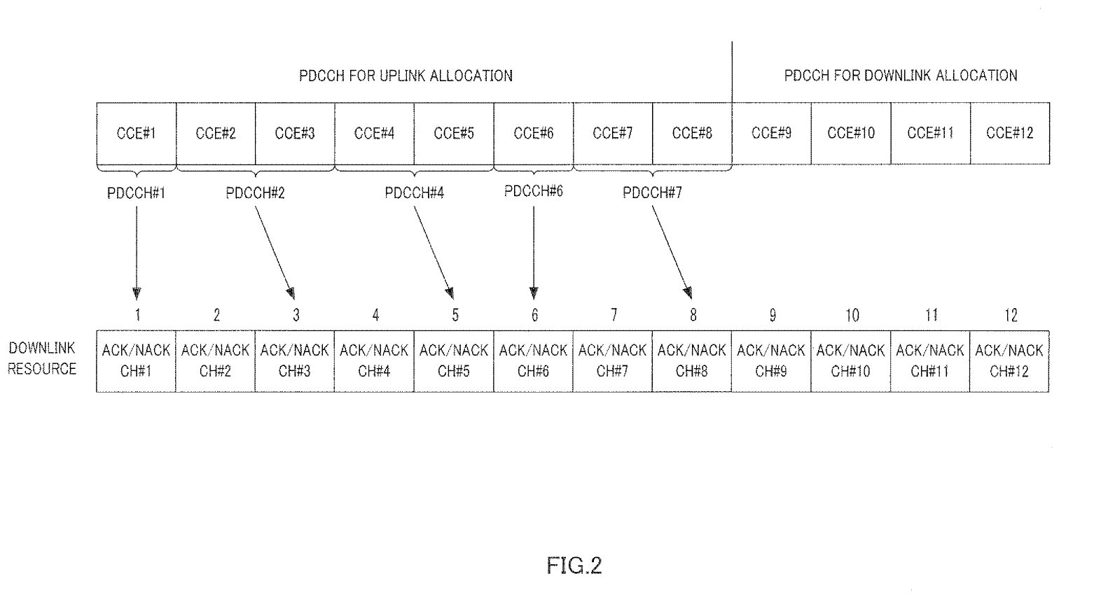

In the following explanation, as shown in the upper part of FIG. 2, twelve CCE's #1 to #12 will be used. Also, PDCCH's for uplink allocation are used in ascending order from CCE #1 to CCE #8, and PDCCH's for downlink allocation are used in descending order from CCE #12 to CCE #9. Also, PDCCH's for uplink allocation and PDCCH's for downlink allocation are comprised of one or a plurality of CCE's of adjacent CCE numbers among the twelve CCE's. For example, as shown in the upper part of FIG. 2, PDCCH #1 is comprised of one CCE of CCE #1, PDCCH #2 is comprised of two CCE's of CCE #2 and CCE #3, PDCCH #4 is comprised of two CCE's of CCE #4 and CCE #5, PDCCH #6 is comprised of one CCE of CCE #6, and PDCCH #7 is comprised of two CCE's of CCE #7 and CCE #8. Here, a PDCCH corresponding to a lower MCS level is comprised of a larger number of CCE's.

Also, as shown in the lower part of FIG. 2, a base station reserves in advance downlink resources, in which maximum twelve ACK/NACK channels CH #1 to CH #12 associated with twelve CCE's #1 to #12, respectively, are arranged. For example, as shown in the lower part of FIG. 2, ACK/NACK channels CH's #1 to #12 associated with CCE's #1 to #12, respectively, are arranged in downlink resources 1 to 12.

As shown in FIG. 2, the CCE comprising PDCCH #1 is CCE #1, and, consequently, upon the first transmission (initial transmission), ACK/NACK channel allocating section 105 allocates a response signal to the uplink data allocated by PDCCH #1, to ACK/NACK channel CH #1 associated with CCE #1. Also, as shown in FIG. 2, the CCE's comprising PDCCH #2 are CCE #2 and CCE #3, and the CCE of a higher CCE number between these two CCE's is CCE #3. Therefore, upon the first transmission (initial transmission), ACK/NACK channel allocating section 105 allocates a response signal to uplink data allocated by PDCCH #2, to ACK/NACK channel CH #3 associated with CCE #3. The same applies to PDCCH's #4, #6 and #7.

Here, if uplink data includes error and requires a second transmission (retransmission), the base station allocates a response signal to uplink data upon a second transmission (first retransmission), to the same ACK/NACK channel as the ACK/NACK channel assigned upon the first transmission (initial transmission). For example, for a mobile station in which a response signal to uplink data upon the first transmission (initial transmission) is allocated to ACK/NACK channel CH #1 shown in FIG. 2, a response signal to uplink data upon a second transmission (first retransmission) is also allocated to ACK/NACK channel CH #1.

Also, taking into account avoidance of collision with an ACK/NACK channel to which a response signal to uplink data upon a second transmission (first retransmission) is allocated, the base station allocates a PDCCH for another mobile station.

For example, as shown in FIG. 2, if a second transmission (first retransmission) is necessary in a mobile station in which a response signal upon the first transmission (initial transmission) is allocated to ACK/NACK channel CH #1, the base station comprises a PDCCH such that a response signal to another uplink data is allocated to an ACK/NACK channel different from ACK/NACK channel CH #1 that is also used upon a second transmission (first retransmission). Here, a response signal is allocated to the ACK/NACK channel associated with the CCE of the highest CCE number among CCE's comprising the PDCCH, so that it is possible to use other PDCCH's than PDCCH #1 comprised of only CCE #1. That is, it is necessary to comprise a PDCCH with a plurality of CCE's including CCE #1. By this means, a response signal to uplink data newly allocated by that PDCCH is allocated to an ACK/NACK channel associated with a CCE different from CCE #1. That is, a response signal to new uplink data is not allocated to ACK/NACK channel CH #1 associated with CCE #1. Therefore, for another mobile station, even in the case of comprising a PDCCH with a plurality of CCE's including CCE #1, it is possible to avoid collision in ACK/NACK channel CH #1 that is also used upon a second transmission (first retransmission).

Also, CCE #8 shown in FIG. 2 has the highest CCE number among CCE's used as the PDCCH for uplink allocation. Therefore, a response signal to uplink data allocated by PDCCH #8 comprised of only CCE #8 and a response signal to uplink data allocated by a PDCCH comprised of a plurality of CCE's including CCE #8, are both allocated to ACK/NACK channel CH #8. Therefore, when ACK/NACK channel CH #8 is used upon a second transmission (first retransmission), it is not possible to comprise PDCCH's including CCE #8 associated with ACK/NACK channel CH #8. However, as shown in FIG. 2, CCE #8 can be used as a PDCCH for downlink allocation, and, by using CCE #8 as the PDCCH for downlink allocation comprised of CCE #8 and adjacent CCE #9, it is possible to prevent communication resources from being wasted.

Also, if the number of mobile stations to which a PDCCH is transmitted varies on a per sub frame basis, the number of CCE's comprising a PDCCH may also be variable. In this case, the CCE of the highest CCE number is used only when the number of mobile stations to which a PDCCH is allocated is maximum. Therefore, as shown in FIG. 2, there is a low probability that a response signal is allocated to ACK/NACK channel CH #8 associated with CCE #8 of the highest CCE number among CCE's #1 to #8 used as PDCCH's for uplink allocation. Therefore, there is also a low probability that ACK/NACK channel CH #8 is used upon a second transmission (first retransmission), so that it is possible to reduce the probability that CCE #8 cannot be used as a PDCCH for uplink allocation, so that the whole system is subject to little influence.

Thus, according to the present embodiment, when a PDCCH is comprised of a plurality of CCE's, a response signal is allocated to an ACK/NACK channel associated with the CCE of the highest CCE number among the plurality of CCE's. By this means, even in the case of continuing using the ACK/NACK channel of the lowest channel number (i.e. ACK/NACK channel CH #1 shown in FIG. 2) for retransmission, by comprising a PDCCH with the CCE associated with that ACK/NACK channel and a different, adjacent CCE, it is possible to reduce the state that the CCE of the lowest CCE number cannot be used, and prevent communication resources form being wasted. Therefore, according to the present embodiment, it is possible to improve data transmission efficiency.

Also, according to the present embodiment, it is possible to use the CCE of the lowest CCE number in each subframe, so that it is possible to suppress an increase or decrease of interference power, which is given to other cells and caused by ON/OFF switching of a CCE transmission on a per subframe basis. By this means, for example, it is possible to improve the accuracy of transmission power control and adaptive MCS control in other cells, and improve the system throughput.

Also, a case has been described above with the present embodiment where PDCCH's for uplink allocation are used in ascending order from the CCE of the lowest CCE number and PDCCE's for downlink allocation are used in descending order from the CCE of the highest CCE number. However, it is equally possible to apply the present invention to a case where PDCCH's for uplink allocation are used in descending order from the CCE of the highest CCE number and PDCCE's for downlink allocation are used in ascending order from the CCE of the lowest CCE number. In this case, if a plurality of CCE's comprise a PDCCH, a response signal is allocated to an ACK/NACK channel associated with the CCE of the lowest CCE number among the plurality of CCE's comprising the PDCCH.

Also, a case has been described above with the present embodiment where a response signal to uplink data upon a second or subsequent transmission (retransmission) is allocated to the same ACK/NACK channel as an ACK/NACK channel assigned upon the first transmission (initial transmission). However, it is equally possible to apply the present invention to a case where a response signal to uplink data upon a second or subsequent transmission (retransmission) is allocated to the ACK/NACK channel associated with the CCE comprising a PDCCH used upon the first transmission (initial transmission). By this means, for example, even if the associations between CCE's and ACK/NACK channels vary over time, a base station can recognize an ACK/NACK channel to which a response signal to uplink data upon a second or subsequent transmission (retransmission) is allocated, and a CCE associated with that ACK/NACK channel. Therefore, the base station can assign a PDCCH for another mobile station, using a CCE that does not collide with an ACK/NACK channel to which a response signal to uplink data upon a second or subsequent transmission (retransmission) is allocated.

Also, although a case has been described above with the present embodiment where uplink allocation information is allocated to a PDCCH 1.5 and transmitted to a mobile station only in the case of uplink data upon the first transmission (initial transmission), it is equally possible to allocate uplink allocation information to a PDCCH and transmit the result to a mobile station in the case of uplink data upon a second or subsequent transmission (retransmission). In this case, it is necessary to adopt uplink data allocated by a PDCCH instead of uplink data upon the first transmission (initial transmission), which has been described above with the present embodiment, and adopt uplink data that is not allocated by a PDCCH instead of uplink data upon a second or subsequent transmission (retransmission), which has been described above with the present embodiment.

Also, although a case has been described above with the present embodiment where a PDCCH is comprised of one CCE or two CCE's, it is equally possible to comprise a PDCCH with three or more CCE's. In this case, it is possible to allocate a response signal to uplink data allocated by a PDCCH, to an ACK/NACK channel associated with a CCE different from the CCE of the lowest CCE number and the CCE of the highest CCE number among the CCE's comprising the PDCCH. By this means, while using ACK/NACK channels associated with the CCE of the lowest CCE number and the CCE of the highest CCE number, it is possible to prevent unavailability of the CCE of the lowest CCE number and the CCE of the highest CCE number.

### Embodiment 2

With the present embodiment, a response signal to uplink data upon a second or subsequent transmission (retransmission) is allocated using an ACK/NACK channel shifted by the number of retransmissions in ascending order from an ACK/NACK channel assigned upon the first transmission (initial transmission).

If a decision result from transmission deciding section 104 indicates the initial transmission, ACK/NACK channel allocating section 105 (in FIG. 1) according to the present embodiment allocates a response signal received as input from modulating section 103, to an ACK/NACK channel based on CCE allocation information received as input from PDCCH allocating section 101. Further, if a plurality of CCE's comprise a PDCCH, ACK/NACK channel allocating section 105 allocates a response signal to an ACK/NACK channel associated with the CCE of the lowest CCE number among the plurality of CCE's comprising the PDCCH. By contrast, if a decision result from transmission deciding section 104 indicates a retransmission, ACK/NACK channel allocating section 105 allocates a response signal to an ACK/NACK channel shifted by the number of retransmissions in ascending order from an ACK/NACK channel assigned upon the first transmission (initial transmission).

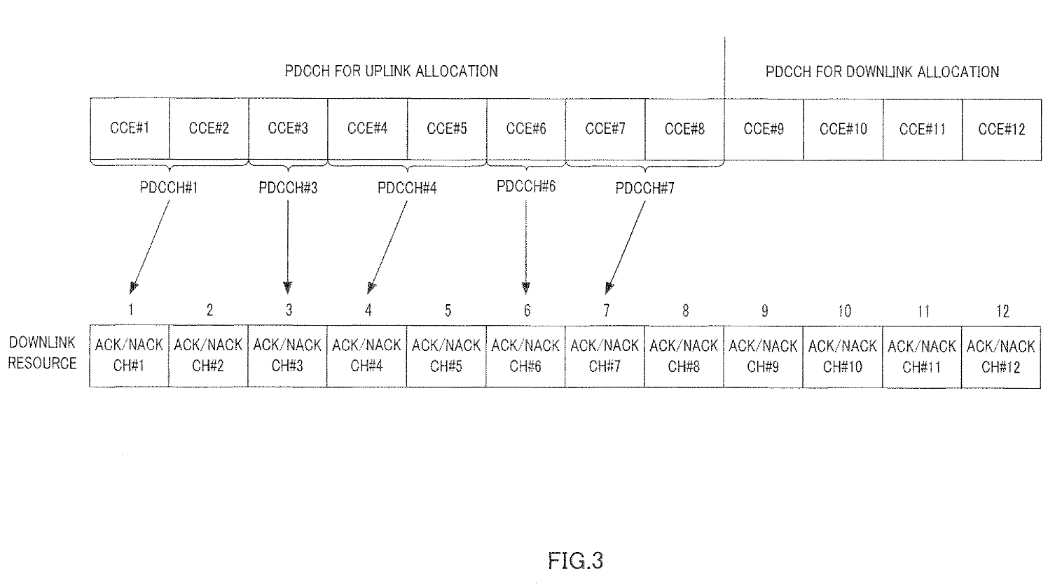

In the following explanation, as shown in the upper part of FIG. 3, twelve CCE's #1 to #12 will be used as in Embodiment 1. Also, as in Embodiment 1, PDCCH's for uplink allocation are used in ascending order from CCE #1 to CCE #8, and PDCCH's for downlink allocation are used in descending order from CCE #12 to CCE #9. Here, as shown in the upper part of FIG. 3, PDCCH's #1, #3, #4, #6 and #7 for uplink allocation are comprised of CCE's #1 to #8.

Also, as shown in the lower part of FIG. 3, as in Embodiment 1, a base station reserves in advance downlink resources 1 to 12 in which maximum twelve ACK/NACK channels CH #1 to #12 associated with twelve CCE's #1 to #12, respectively, are arranged.

As shown in FIG. 3, the CCE's comprising PDCCH #1 are CCE #1 and CCE #2, and the CCE of a lower CCE number between these two CCE's is CCE #1. Therefore, upon the first transmission (initial transmission), ACK/NACK channel allocating section 105 allocates a response signal to uplink data allocated by PDCCH #1, to ACK/NACK channel CH #1 associated with CCE #1. Also, as shown in FIG. 3, the CCE comprising PDCCH #3 is CCE #3, and, upon the first transmission (initial transmission), ACK/NACK channel allocating section 105 allocates a response signal to uplink data allocated by PDCCH #3, to ACK/NACK channel CH #3 associated with CCE #3. The same applies to PDCCH's #4, #6 and #7.

Next, if uplink data includes error and requires a second transmission (first retransmission), the base station allocates a response signal to the uplink data upon a second transmission (first retransmission), to an ACK/NACK channel shifted by one in ascending order from the ACK/NACK channel assigned upon the first transmission (initial transmission). For example, for a mobile station in which a response signal to uplink data upon the first transmission (initial transmission) is allocated to ACK/NACK channel CH #1, a response signal to uplink data upon a second transmission (first retransmission) is allocated to ACK/NACK channel CH #2 shifted by one in ascending order from ACK/NACK channel. CH #1, as shown in FIG. 3.

Also, as in Embodiment 1, taking into account avoidance of collision with an ACK/NACK channel to which a response signal to uplink data upon a second transmission (first retransmission) is allocated, the base station assigns a PDCCH to another mobile station.

For example, as shown in FIG. 3, if a second transmission (first retransmission) is necessary in a mobile station in which a response signal upon the first transmission (initial transmission) is allocated to ACK/NACK channel CH #1, the base station comprises a PDCCH such that a response signal to new uplink data is allocated to an ACK/NACK channel different from ACK/NACK channel CH #2 used upon a second transmission (first retransmission). Here, a response signal is allocated to an ACK/NACK channel associated with the CCE of the lowest CCE number among the CCE's comprising a PDCCH, so that, if the CCE of the lowest CCE number is not CCE #2, it is possible to comprise a plurality of PDCCH's including CCE #2. By this means, response signals to uplink data newly allocated by the PDCCH's are allocated to ACK/NACK channels associated with CCE's other than CCE #2. That is, response signals to new uplink data are not allocated to ACK/NACK channel CH #2 associated with CCE #2. Therefore, for another mobile station, even if PDCCH #1 including CCE #1 of a lower CCE number than CCE #2 is comprised, it is possible to avoid collision in ACK/NACK channel CH #2 also used upon a second transmission (first retransmission).

Also, a response signal to uplink data upon a second transmission (retransmission) is not allocated to ACK/NACK channel CH #1 of the lowest channel number among ACK/NACK channels CH #1 to CH #12 shown in FIG. 3. Therefore, it is possible to always allocate a response signal to uplink data upon the first transmission (initial transmission), to ACK/NACK channel CH #1. That is, the base station can always use CCE #1 associated with ACK/NACK channel CH #1 as a PDCCH for uplink allocation for a mobile station to which control information is newly allocated.

Thus, if a second or subsequent transmission (retransmission) of uplink data is necessary, the present embodiment allocates a response signal to the uplink data to an ACK/NACK channel shifted by the number of retransmissions in ascending order from an ACK/NACK channel assigned upon the first transmission (initial transmission). By this means, the ACK/NACK channel of the lowest channel number (ACK/NACK channel CFI #1 shown in FIG. 3) is always used only upon the first transmission (initial transmission), so that it is possible to prevent unavailability of the CCE of the lowest CCE number associated with the ACK/NACK channel. Therefore, according to the present embodiment, as in Embodiment 1, it is possible to improve data transmission efficiency.

Also, with the present embodiment, when a second transmission (first retransmission) is necessary in an ACK/NACK channel (e.g. ACK/NACK channel CH #8 shown in FIG. 3) associated with the CCE of the highest CCE number (e.g. CCE #8 shown in FIG. 3) among CCE's used as PDCCH's for uplink allocation, it is possible to perform a cyclic shift to an ACK/NACK channel (e.g. ACK/NACK channel CH #1 shown in FIG. 3) associated with the CCE of the lowest CCE number (e.g. CCE #1 shown in FIG. 3). Here, the CCE of the highest CCE number is used only when the number of mobile stations to which a PDCCH is allocated is maximum. Therefore, there is a low probability that a response signal is allocated to an ACK/NACK channel associated with the CCE of the highest CCE number among CCE's used as PDCCH's for uplink allocation. Therefore, there is also a low probability that an ACK/NACK channel associated with the CCE of the highest CCE number is used upon a second transmission (first retransmission), so that there is also a low probability that an ACK/NACK channel associated with the CCE of the lowest CCE number is subject to a cyclic shift, so that the whole system is subject to little influence.

Also, although a case has been described above with the present embodiment where, if a second transmission (first retransmission) is necessary, an ACK/NACK channel shifted by one in ascending order from an ACK/NACK channel assigned upon the first transmission (initial transmission) is used, it is equally possible to use an ACK/NACK channel shifted by two or more from an ACK/NACK channel assigned upon the first transmission (initial transmission).

### Embodiment 3

With the present embodiment, a response signal to uplink data upon a second or subsequent transmission (retransmission) is allocated to an ACK/NACK channel of a higher channel number when an ACK/NACK channel assigned upon the first transmission (initial transmission) has a lower channel number. That is, a response signal to uplink data upon a second or subsequent transmission (retransmission) is allocated to an ACK/NACK channel of a channel number having a mirror-image relationship with the channel number of an ACK/NACK channel assigned upon the first transmission (initial transmission).

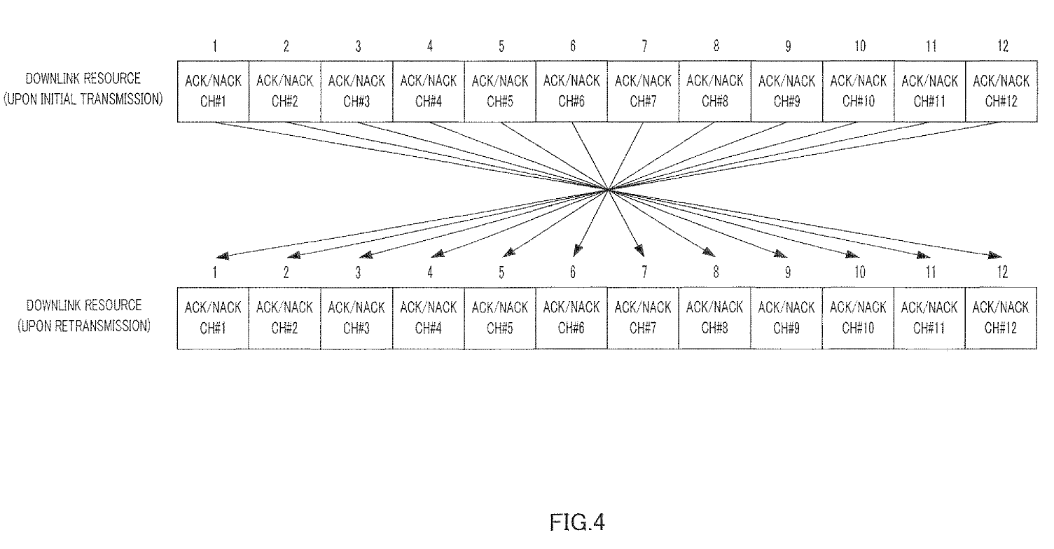

If a decision result from transmission deciding section 104 indicates the initial transmission, ACK/NACK channel allocating section 105 (in FIG. 1) according to the present embodiment allocates a response signal received as input from modulating section 103, to an ACK/NACK channel based on CCE allocation information received as input from PDCCH allocating section 101. Also, if a plurality of CCE's comprise a PDCCH, as in Embodiment 2, ACK/NACK channel allocating section 105 allocates a response signal to an ACK/NACK channel associated with the CCE of the lowest CCE number among the plurality of CCE's comprising the PDCCH. By contrast, if a decision result from transmission deciding section 104 indicates a retransmission, ACK/NACK channel allocating section 105 allocates a response signal to an ACK/NACK channel of a higher channel number when an ACK/NACK channel assigned upon the first transmission (initial transmission) has a lower channel number. To be more specific, when the total number of CCE's (equivalent to the number of ACK/NACK channels) is N and the channel number of an ACK/NACK channel assigned upon the first transmission (initial transmission) is #k, ACK/NACK channel allocating section 105 allocates a response signal to an ACK/NACK channel of channel number CH #(N−(k−1)). That is, as shown in FIG. 4, ACK/NACK channel allocating section 105 allocates a response signal to an ACK/NACK channel of a channel number having a mirror-image relationship with the channel number of an ACK/NACK channel assigned upon the first transmission (initial transmission).

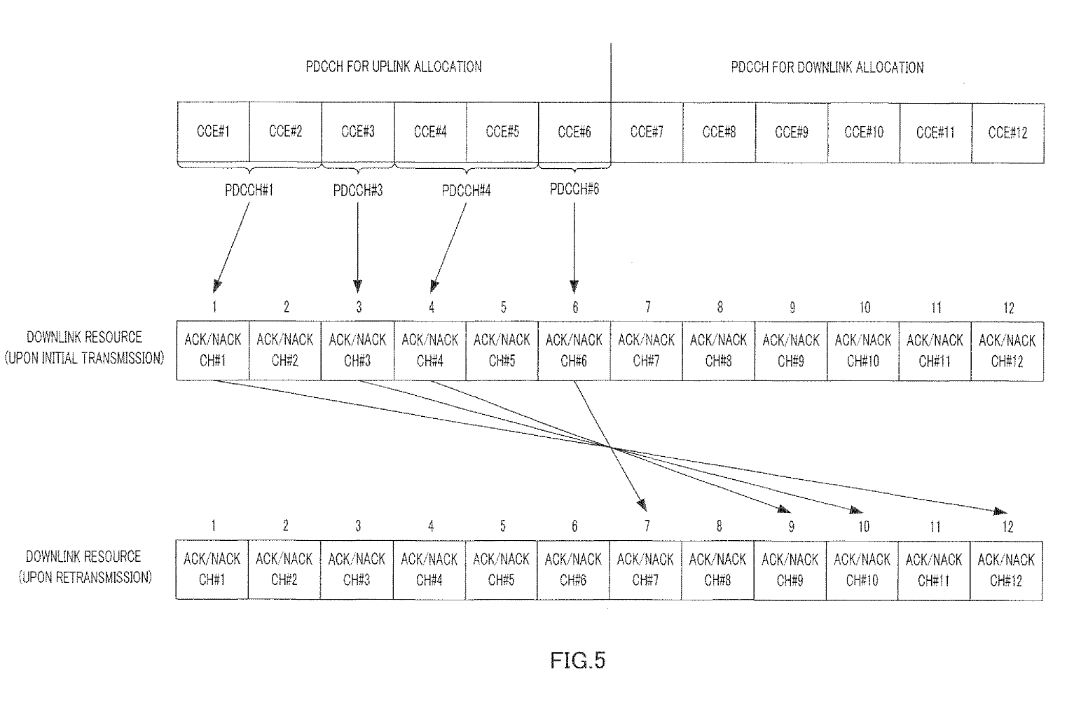

In the following explanation, as shown in the upper part of FIG. 5, as in Embodiment 1, twelve CCE's #1 to #12 (N=12) will be used. Also, PDCCH's for uplink allocation are used in ascending order from CCE #1 to CCE #6, and PDCCH's for downlink allocation are used in descending order from CCE #12 to CCE #7. Here, as shown in the upper part of FIG. 5, PDCCH's #1, #3, #4 and #6 for uplink allocation are comprised of CCE's #1 to #6.

Also, as shown in the middle part of FIG. 5, as in Embodiment 1, the base station reserves in advance downlink resources 1 to 12 in which maximum ACK/NACK channels CH #1 to #12 associated with twelve CCE's #1 to #12, respectively, are arranged.

As shown in the middle part of FIG. 5, upon the first transmission (initial transmission), as in Embodiment 2, ACK/NACK channel allocating section 105 allocates response signals to uplink data allocated by PDCCH's #1, #3, #4 and #6, to ACK/NACK channels CH #1, CH #3, CH #4 and CH #6, respectively.

Next, if uplink data includes error and requires a second transmission (first retransmission), the base station allocates a response signal to uplink data upon a second transmission (first retransmission), to an ACK/NACK channel of a higher channel number when an ACK/NACK channel assigned upon the first transmission (initial transmission) has a lower channel number. For example, for a mobile station in which a response signal to uplink data upon the first transmission (initial transmission) is allocated to ACK/NACK channel CH #1 (k=1), a response signal to uplink data upon a second transmission (first retransmission) is allocated to ACK/NACK channel CH #12 (=12−(1−1)), as shown in the lower part of FIG. 5. Similarly, for a mobile station in which a response signal to uplink data upon the first transmission (initial transmission) is allocated to ACK/NACK channel CH #3 (k=3), a response signal to uplink data upon a second transmission (first retransmission) is allocated to ACK/NACK channel CH #10 (=12−(3−1)), as shown in the lower part of FIG. 5. The same applies to mobile stations in which response signals to uplink data upon the first transmission (initial transmission) are allocated to ACK/NACK channels CH #4 and CH #6 shown in FIG. 5. Thus, the base station allocates response signals to uplink data upon a second transmission (first retransmission), to ACK/NACK channels (ACK/NACK channels CH #12, CH #10, CH #9 and CH #7 shown in FIG. 4) having a mirror-image relationship with ACK/NACK channels (ACK/NACK channels CH #1, CH #3, CH #4 and CH #6 shown in FIG. 4) to which response signals to uplink data upon the first transmission (initial transmission) are allocated.

Also, as in Embodiment 2, taking into account avoidance of collision with an ACK/NACK channel to which a response signal to uplink data upon a second transmission (first retransmission) is allocated, the base station assigns a PDCCH for another mobile station.

For example, as shown in FIG. 5, if a second transmission (first retransmission) is necessary in a mobile station in which a response signal upon the first transmission (initial transmission) is allocated to ACK/NACK channel CH #1, the base station comprises a PDCCH for uplink allocation such that a response signal to new uplink data is allocated to an ACK/NACK channel different from ACK/NACK channel CH #12 used upon a second transmission (first retransmission).

Here, in CCE's #1 to #12 shown in FIG. 5, CCE #1 of the lowest CCE number is used most frequently as a PDCCH for uplink allocation, and CCE #12 of the highest CCE number is used most frequently as a PDCCH for downlink allocation. In other words, CCE #12 of the highest CCE number is used least frequently as a PDCCH for uplink allocation. Therefore, there is a low probability that a response signal to uplink data upon the first transmission (initial transmission) is allocated to ACK/NACK channel CH #12 (k=12) of the highest channel number. In other words, there is a low probability that a response signal is allocated to ACK/NACK channel CH #1 (=12−(12−1)) upon a second transmission (first retransmission). That is, it is possible to allocate a response signal to uplink data upon the first transmission (initial transmission) to ACK/NACK channel CH #1 of the lowest channel number at a high probability. That is, the base station can use CCE #1 associated with ACK/NACK channel CH #1 at a high probability, as a PDCCH for uplink allocation for a mobile station to which control information is newly allocated.

Thus, a response signal to uplink data upon a second transmission (first retransmission) is likely to be allocated to an ACK/NACK channel associated with a CCE to which a PDCCH for uplink allocation is assigned less frequently (i.e. a CCE to which a PDCCH for downlink allocation is assigned more frequently). Here, if a CCE is used as a PDCCH for downlink allocation, an ACK/NACK channel associated with the CCE is not used.

Therefore, even if a second transmission (first retransmission) of uplink data is necessary, the base station can assign a PDCCH for another mobile station, using a CCE that is used frequently as a PDCCH for uplink allocation, that is, using a CCE associated with an ACK/NACK channel to which a response signal upon a retransmission is less likely to be allocated (e.g. CCE's #1 to #6 in FIG. 5). Also, there is a higher probability that a response signal upon a retransmission is allocated to an ACK/NACK channel associated with a CCE that is used less frequently as a PDCCH for uplink allocation (e.g. CCE's #7 to #12). Therefore, the base station can efficiently use downlink resources 1 to 12 in which ACK/NACK channels are arranged.

Thus, according to the present embodiment, a response signal to uplink data upon a second transmission (first retransmission) is allocated to an ACK/NACK channel having a mirror-image relationship with the channel number of an ACK/NACK channel assigned upon the first transmission (initial transmission). By this means, it is possible to use an ACK/NACK channel of the lowest channel number (ACK/NACK channel CH #1 shown in FIG. 5) at a high probability upon the first transmission (initial transmission), so that it is possible to prevent unavailability of the CCE of the lowest CCE number associated with that ACK/NACK channel. Therefore, according to the present embodiment, as in Embodiment 1, it is possible to improve data transmission efficiency.

Further, according to the present embodiment, a response signal upon a second transmission (first retransmission) is allocated to an ACK/NACK channel associated with a CCE that is used less frequently as a PDCCH for uplink allocation. Therefore, in a base station, upon assigning a PDCCH for another mobile station, it is further possible to alleviate the CCE use restriction for avoidance of collision with an ACK/NACK channel to which a response signal upon a second transmission (first retransmission) is allocated. Therefore, according to the present embodiment, it is possible to improve CCE use efficiency. Also, a response signal upon a second transmission (first retransmission) is allocated to an ACK/NACK channel associated with a CCE that is used less frequently as a PDCCH for uplink allocation, so that it is possible to improve use efficiency of downlink resources in which ACK/NACK channels are arranged.

Also, although an allocating method of ACK/NACK channels within a second transmission (first retransmission) has been described above with the present embodiment, it is equally possible to apply the present invention to a third (i.e. second retransmission) or subsequent transmission. To be more specific, a response signal to uplink data upon each retransmission is allocated to an ACK/NACK channel having a mirror-image relationship with an ACK/NACK channel used upon the previous transmission (where the mirror-image relationship is the relationship between above channel number #k and channel number #(N−(k−1)). For example, as described above, ACK/NACK channel allocating section 105 allocates a response signal to uplink data upon the first transmission (initial transmission) to ACK/NACK channel CH #1, and allocates a response signal to uplink data upon a second transmission (first retransmission) to ACK/NACK channel CH #12 (having a mirror-image relationship with ACK/NACK channel CH #1). Further, ACK/NACK channel allocating section 105 allocates a response signal to uplink data upon a third transmission (i.e. second retransmission) to ACK/NACK channel CH #1 (having a mirror-image relationship with ACK/NACK channel CH #12). By this means, even if a third or subsequent transmission (i.e. second or subsequent retransmission) is necessary, it is possible to avoid collision between an ACK/NACK channel, to which a response signal to uplink data upon a second transmission (first retransmission) is allocated, and an ACK/NACK channel to which a response signal to uplink data for a third or subsequent transmission (i.e. second or subsequent retransmission) is allocated. Therefore, it is not necessary to separately reserve an ACK/NACK channel to which a response signal to uplink data upon a third or subsequent transmission (i.e. second or subsequent retransmission) is allocated. Also, to avoid collision with an ACK/NACK channel to which a response signal to a third or subsequent transmission (i.e. second or subsequent retransmission) is allocated, a use of CCE's for another mobile station is restricted. However, there is a low probability that a third or subsequent transmission (i.e. second or subsequent retransmission) is necessary, so that the whole system is subject to little influence.

Also, according to the present embodiment, when the number of CCE's used by a plurality of PDCCH's for uplink allocation is equal to or more than seven, a response signal to uplink data upon the first transmission (initial transmission) in a mobile station, which is indicated by a CCE of a CCE number equal to or greater than seven, is allocated to an ACK/NACK channel of a channel number equal to or greater than seven. Here, if a second transmission (first retransmission) is necessary, the channel number of an ACK/NACK channel having a mirror-image relationship (in FIG. 4) with an ACK/NACK channel upon the first transmission (initial transmission) is equal to or less than six. Therefore, to avoid collision between an ACK/NACK channel upon a second transmission (first retransmission) and an ACK/NACK channel used by another mobile station, a use of CCE's for that mobile station is restricted. Here, a case is rare where the number of CCE's used by a plurality of PDCCH's for uplink allocation requires seven or more, that is, where a half or more of the total number of CCE's are necessary, so that the whole system is subject to little influence.

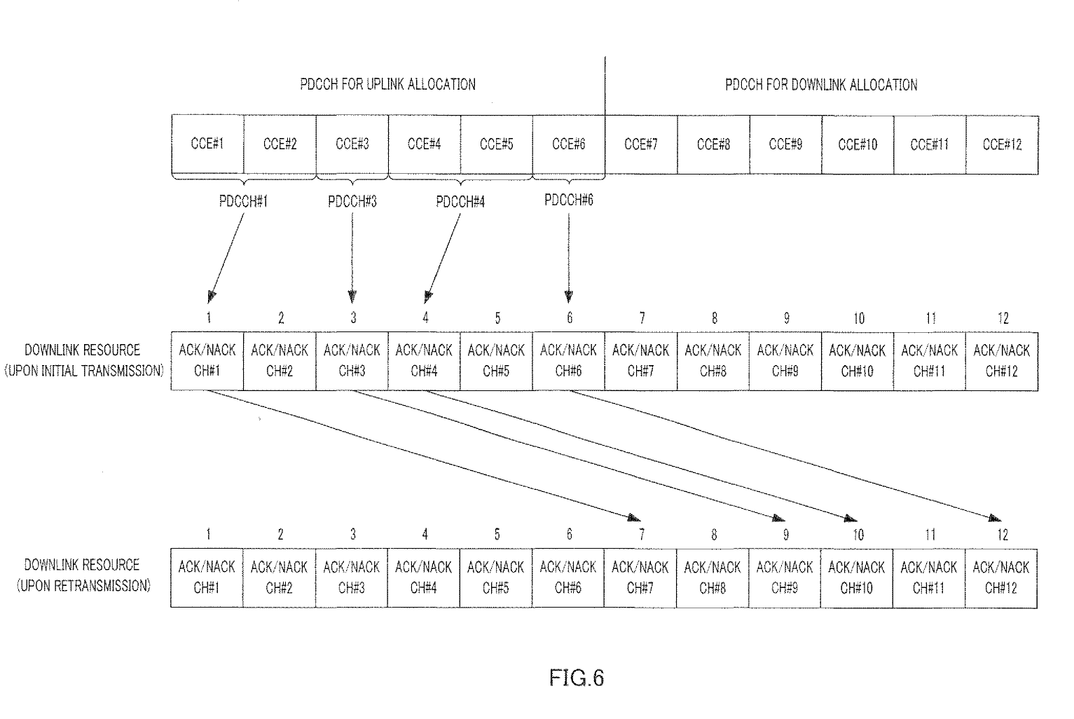

Also, when a second or subsequent transmission (retransmission) is necessary, it is possible to allocate a response signal to uplink data to an ACK/NACK channel cyclically shifted by a half the total number of CCE's from an ACK/NACK channel assigned upon the first transmission (initial transmission). To be more specific, when the total number of CCE's is N and the channel number of an ACK/NACK channel assigned upon the first transmission (initial transmission) is #k, ACK/NACK channel allocating section 105 allocates a response signal to uplink data upon a second transmission (first retransmission) to an ACK/NACK channel of channel number CH # (((k−1)+N/2)mod N)+1. For example, for a mobile station in which a response signal to uplink data upon the first transmission (initial transmission) is allocated to ACK/NACK channel CH #1 (k=1), as shown in the lower part of FIG. 6, a response signal to uplink data upon a second transmission (first retransmission) is allocated to ACK/NACK channel CH #7 (=(((1−1)+6)mod 12)+1). Similarly, for a mobile station in which a response signal to uplink data upon the first transmission (initial transmission) is allocated to ACK/NACK channel CH #3 (k32 3), as shown in the lower part of FIG. 6, a response signal to uplink data upon a second transmission (first retransmission) is allocated to ACK/NACK channel CH #9 (=(((3−1)+6)mod 12)+1). The same applies to mobile stations in which response signals to uplink data upon the first transmission (initial transmission) are allocated to ACK/NACK channels CH #4 and CH #6 shown in FIG. 6. By this means, even in the case of continuing transmitting a response signal to uplink data upon a second or subsequent transmission (retransmission), as in the present embodiment, it is possible to allocate a response signal upon a second transmission (first retransmission) to an ACK/NACK channel associated with a CCE of a higher CCE number, that is, associated with a CCE that is used less frequently as a PDCCH for uplink allocation, so that it is possible to provide the same effect as in the present embodiment.

### Embodiment 4

With the present embodiment, an ACK/NACK channel, to which a response signal to uplink data upon the first transmission (initial transmission) is allocated, is switched in predetermined time units.

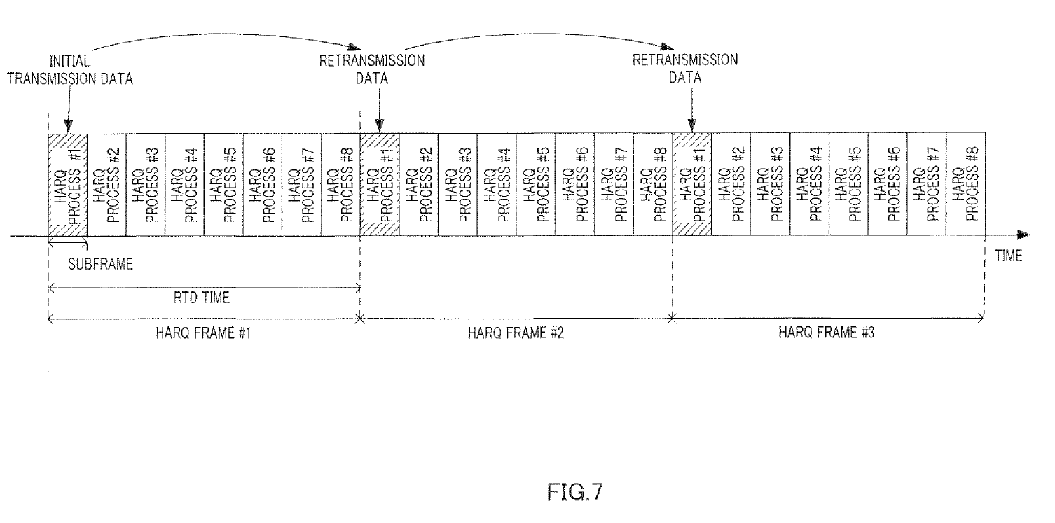

A case will be explained below where the predetermined time unit is the RTD (Round Trip Delay) time, which is the time interval between the first transmission (initial transmission) and a second transmission (first retransmission). As shown in FIG. 7, when HARQ process is eight, there are eight HARQ processes (HARQ processes #1 to #8) in an RTD time. That is, the RTD time is comprised of eight subframes. Also, the time unit divided by the RTD time is referred to as a “HARQ frame.”

If a decision result from transmission deciding section 104 indicates the initial transmission, ACK/NACK channel allocating section 105 according to the present embodiment (in FIG. 1) allocates a response signal received as input from modulating section 103, to an ACK/NACK channel based on an HARQ frame number and CCE allocation information received as input from PDCCH allocating section 101. To be more specific, in an HARQ frame of an HARQ frame number that is an odd number, ACK/NACK channel allocating section 105 allocates a response signal to an ACK/NACK channel of the channel number (i.e. channel number CH #k) corresponding to the CCE number of the CCE having the lowest CCE number (i.e. CCE number #k) among a plurality of CCE's comprising a PDCCH. Also, in an HARQ frame of an HARQ frame number that is an even number, ACK/NACK channel allocating section 105 allocates a response signal to an ACK/NACK channel of the channel number (channel number CH #(N−(k−1))) having a mirror-image relationship with the CCE number of the CCE having the lowest CCE number (i.e. CCE number #k) among a plurality of CCE's comprising a PDCCH.

By contrast, if a decision result from transmission deciding section 104 indicates a retransmission, ACK/NACK channel allocating section 105 allocates a response signal to the same ACK/NACK channel as an ACK/NACK channel assigned upon the first transmission (initial transmission).

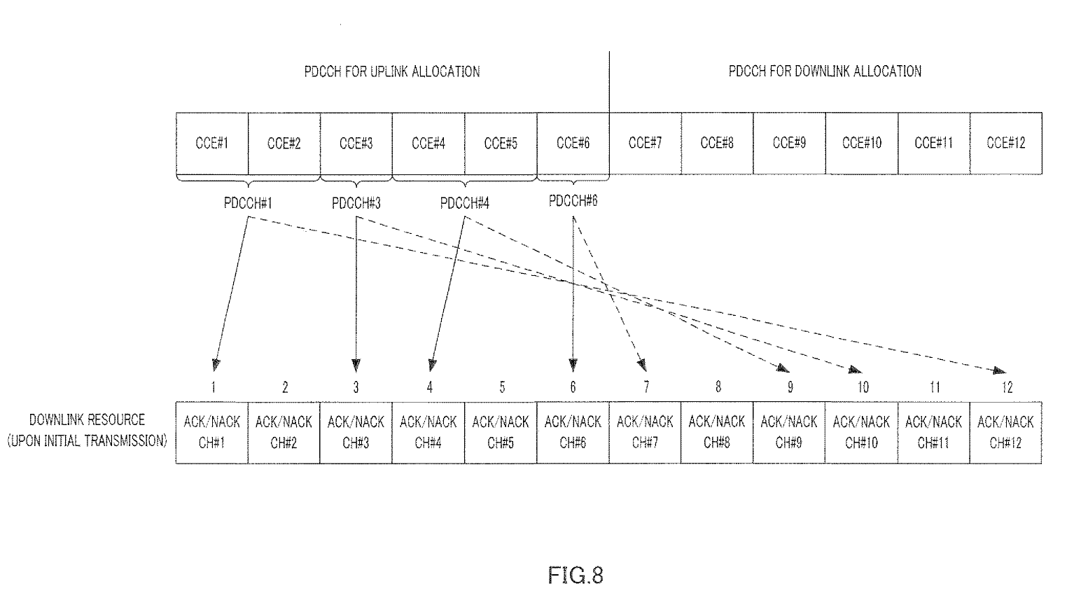

As shown in the upper part of FIG. 8, as in Embodiment 1, twelve CCE's #1 to #12 are used in the following explanation. Also, as in Embodiment 3, PDCCH's for uplink allocation are used in ascending order from CCE #1 to CCE #6, and PDCCH's for downlink allocation are used in descending order from CCE #12 to CCE #7. Also, as shown in the upper part of FIG. 8, PDCCH's #1, #3, #4 and #6 for uplink allocation are comprised of CCE's #1 to #6.

Also, as shown in the lower part of FIG. 8, as in Embodiment 1, a base station reserves in advance downlink resources 1 to 12 in which maximum twelve ACK/NACK channels CH #1 to CH #12 associated with twelve CCE's #1 to #12 are arranged.

First, assignment of ACK/NACK channels in an HARQ frame of an HARQ frame number that is an odd number will be explained. As shown in FIG. 8, ACK/NACK channel allocating section 105 allocates a response signal to uplink data upon the first transmission (initial transmission), on a per PDCCH basis, to an ACK/NACK channel (indicated by a solid-line arrow in FIG. 8) of the same channel number as the CCE number of the CCE having the lowest CCE number among a plurality of CCE's comprising a PDCCH. To be more specific, as shown in FIG. 8, upon the first transmission (initial transmission) in HARQ frames of HARQ frame numbers that are odd numbers, ACK/NACK channel allocating section allocates response signals to uplink data allocated by PDCCH's #1, #3, #4 and #6, to ACK/NACK channels CH #1, CH #3, CH #4 and CH #6, respectively.

Next, assignment of ACK/NACK channels in an HARQ frame of an HARQ frame number that is an even number will be explained. As shown in FIG. 8, ACK/NACK channel allocating section 105 allocates a response signal to uplink data upon the first transmission (initial transmission), on a per PDCCH basis, to an ACK/NACK channel (indicated by a dot-line arrow in FIG. 8) of the channel number having a mirror-image relationship with the CCE number of the CCE having the lowest CCE number among a plurality of CCE's comprising a PDCCH. To be more specific, as shown in FIG. 8, upon the first transmission (initial transmission) in HARQ frames of HARQ frame numbers that are even numbers, ACK/NACK channel allocating section 105 allocates response signals to uplink data allocated by PDCCH's #1, #3, #4 and #6 to ACK/NACK channels CH #12, CH #10, CH #9 and CH #7, respectively.

Also, if a second transmission (first retransmission) of uplink data is necessary, ACK/NACK channel allocating section 105 allocates a response signal to the uplink data upon a second transmission (first retransmission), to the same ACK/NACK channel as an ACK/NACK channel assigned upon the first transmission (initial transmission). For example, as shown in FIG. 8, ACK/NACK channel allocating section 105 allocates response signals to uplink data upon a second transmission (first retransmission) in an HARQ frame of an HARQ frame number that is an even number, to the same ACK/NACK channels CH #1, CH #3, CH #4 and CH #6 as the ACK/NACK channels assigned upon the first transmission (initial transmission) in an HARQ frame of an HARQ frame number that is an odd number.

Thus, as shown in the solid-line arrows and dot-line arrows in FIG. 8, associations between CCE's and ACK/NACK channels are switched per HARQ frame. For example, in an HARQ frame of an HARQ frame number that is an even number, a response signal upon a second transmission (first retransmission) is allocated to one of ACK/NACK channels CH #1 to #6 having same channel numbers as the CCE numbers of CCE's (i.e. CCE's #1 to #6 shown in FIG. 8) that are used more frequently for PDCCH's for uplink allocation. By contrast with this, in an HARQ frame of an HARQ frame number that is an even number, a response signal upon the first transmission (initial transmission) is allocated to one of ACK/NACK channels CH #12 to #7 having a mirror-image relationship with the CCE numbers of CCE's (i.e. CCE'S #7 to #12) that are used more frequently for PDCCH's for uplink allocation.

Also, PDCCH's for uplink allocation are assigned in ascending order from the CCE of the lowest CCE number, and, consequently, in an HARQ frame of an HARQ frame number that is an even number, a response signal upon a second transmission (i.e. a retransmission in a mobile station in which the initial transmission is performed in an HARQ frame of an HARQ frame number that is an odd number) is more likely to be allocated to an ACK/NACK channel of a lower channel number. By contrast, in an HARQ frame of an HARQ frame number that is an even number, by using an ACK/NACK channel of the channel number having a mirror-image relationship with the CCE number of a CCE used for a PDCCH for uplink allocation, a response signal upon the first transmission (initial transmission) is more likely to allocate to an ACK/NACK channel of a higher channel number. That is, an ACK/NACK channel to which a response signal upon a second transmission (first retransmission) is allocated is less likely to be equal to an ACK/NACK channel to which a response signal upon the first transmission (initial transmission) is allocated. Therefore, in an HARQ frame of an HARQ frame number that is an even number, although the base station allocates CCE's comprising a PDCCH for another mobile station with consideration of avoidance of collision with an ACK/NACK channel to which a response signal upon a second transmission (first retransmission) is allocated, a use of CCE's is not restricted in most cases. Also, the same applies to an HARQ frame of an HARQ frame number that is an odd number.

Thus, according to the present embodiment, in the case of an HARQ frame of an HARQ frame number that is an odd number, a response signal is allocated to an ACK/NACK channel of a same channel number as the CCE number of a CCE assigned for a PDCCH for uplink allocation. Also, in the case of an HARQ frame of an HARQ frame number that is an even number, a response signal is allocated to an ACK/NACK channel of a channel number having a mirror-image relationship with the CCE number of a CCE assigned for a PDCCH for uplink allocation. By this means, even if the ACK/NACK channel of the lowest channel number (ACK/NACK channel CH #1 shown in FIG. 8) is used upon a second transmission (initial transmission), the CCE of the lowest CCE number corresponding to that ACK/NACK channel is associated with a different ACK/NACK channel in the next HARQ frame. Therefore, it is possible to prevent unavailability of the CCE of the lowest CCE number. Thus, according to the present embodiment, it is possible to prevent unavailability of the CCE of the lowest CCE number and improve data transmission efficiency as in Embodiment 1.

Further, according to the present embodiment, for example, in an HARQ frame of an HARQ frame number that is an odd number, an ACK/NACK channel associated with a CCE that is used more frequently as a PDCCH for uplink allocation (i.e. a CCE of a lower CCE number) is used. Further, in an HARQ frame of an HARQ frame number that is an even number in which a second transmission (first retransmission) in a mobile station is performed using that ACK/NACK channel, an ACK/NACK channel of a larger channel number is used for a response signal upon the first transmission (initial transmission) in another mobile station. By this means, in an HARQ frame of an HARQ frame number that is an even number, when a base station assigns a PDCCH for uplink allocation to another mobile station, CCE use restriction for avoiding collision with an ACK/NACK channel upon a second transmission (first retransmission) decreases. Therefore, according to the present embodiment, CCE use efficiency at a base station improves. Also, the same applies to an HARQ frame of an HARQ frame number that is an odd number.

Also, if a third transmission (i.e. second retransmission) is necessary, a use of CCE's for another mobile station is restricted to avoid collision between an ACK/NACK channel, to which a response signal upon a third transmission (i.e. second retransmission) is allocated, and an ACK/NACK channel to which a response signal upon the first transmission (initial transmission) in another mobile station is allocated. However, there is a low probability that a third or subsequent transmission (i.e. second or subsequent retransmission) is necessary, so that the whole system is subject to little influence.

Also, in associations between CCE's and ACK/NACK channels in an HARQ frame of an HARQ frame number that is an even number, it may be possible to perform allocation to an ACK/NACK channel of a channel number cyclically shifted by a half of the total number of CCE's from the CCE number of a CCE used as a PDCCH for uplink allocation. To be more specific, when the total number of CCE's is N and a CCE number used for a PDCCH for uplink allocation is #k, ACK/NACK channel allocating section 105 allocates a response signal to an ACK/NACK channel of channel number CH #(((k−1)+N/2)mod N)+1. By this means, as in the present embodiment, in an HARQ frame of an HARQ frame number that is an even number, an ACK/NACK channel associated with a CCE used less frequently for a PDCCH for uplink allocation (i.e. a CCE that is used more frequently for a PDCCH for downlink allocation), is used as an ACK/NACK channel upon a second transmission (first retransmission). Therefore, it is possible to provide the same effect as in the present embodiment.

Also, according to the present embodiment, when the number of CCE's used as a plurality of PDCCH's for uplink allocation is equal to or more than seven, the channel number of an ACK/NACK channel, to which a response signal to uplink data upon a second transmission (first retransmission) in a mobile station which is indicated by a CCE of a CCE number equal to or greater than seven, is allocated, is equal to or less than six. Consequently, there is a probability of collision with an ACK/NACK channel to which a response signal to uplink data upon the first transmission (initial transmission) for another mobile station is allocated. Therefore, a use of CCE's for that mobile station is restricted to avoid collision in that ACK/NACK channel. However, a case is rare where the number of CCE's used by a plurality of PDCCH's for uplink allocation requires seven or more, that is, where a half or more of the total number of CCE's are required, so that the whole system is subject to little influence.

Also, although a case has been described above with the present embodiment where the number of HARQ processes is an odd number (i.e. the RTD time is equivalent to even-numbered subframes), it is equally possible to apply the present invention even to a case where the number of HARQ processes is an odd number (i.e. the RTD time is equivalent to odd-number subframes). If the number of HARQ processes is an odd number, an ACK/NACK channel used for a response signal to uplink data upon the first transmission (initial transmission) may be switched in subframe units. In this case, an association with CCE's varies between an ACK/NACK channel to which a response signal upon a second or subsequent transmission (retransmission) is allocated and an ACK/NACK channel to which a response signal to uplink data upon the first transmission (initial transmission) for another mobile station is allocated, so that it is possible to provide the same effect as in the present embodiment.

### Embodiment 5

With the present embodiment, CCE's in which a PDCCH for uplink allocation and a PDCCH for downlink allocation are arranged are switched in predetermined time units.

Here, as in Embodiment 4, a case will be explained where a predetermined time unit is the HARQ RTD time shown in FIG. 7.

In an HARQ frame of an HARQ frame number that is an odd number, PDCCH allocating section 101 (in FIG. 1) according to the present embodiment assigns PDCCH's for uplink allocation in ascending order from the CCE of the lowest CCE number, and assigns PDCCH's for downlink allocation in descending order from the CCE of the highest CCE number. By contrast, in an HARQ frame of an HARQ frame number that is an even number, PDCCH allocating section 101 assigns PDCCH's for uplink allocation in descending order from the CCE of the highest CCE number, and assigns PDCCH's for downlink allocation in ascending order from the CCE of the lowest CCE number.

If a decision result from transmission deciding section 104 indicates the initial transmission, ACK/NACK channel allocating section 105 (in FIG. 1) according to the present embodiment allocates a response signal received as input from modulating section 103, to an ACK/NACK channel based on CCE allocation information received as input from PDCCH allocating section 101. To be more specific, ACK/NACK channel allocating section 105 allocates a response signal to an ACK/NACK channel associated with the CCE number of the CCE having the lowest CCE number among a plurality of CCE's comprising a PDCCH. Also, if a decision result from transmission deciding section 104 indicates a retransmission, ACK/ANCK channel allocating section 105 allocates a response signal to the same ACK/NACK channel as an ACK/NACK channel upon the first transmission (initial transmission).

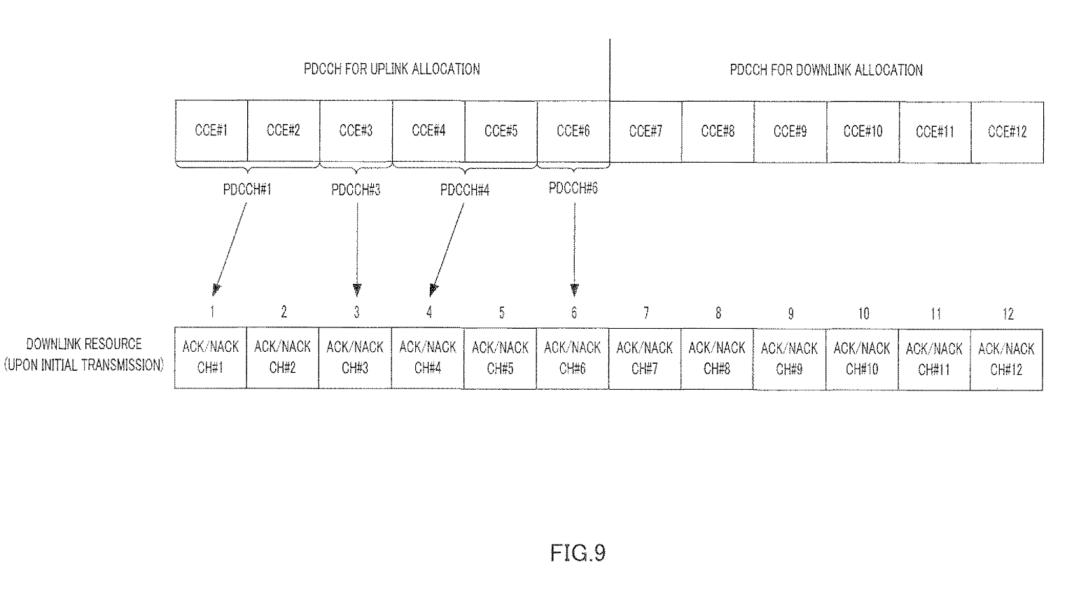

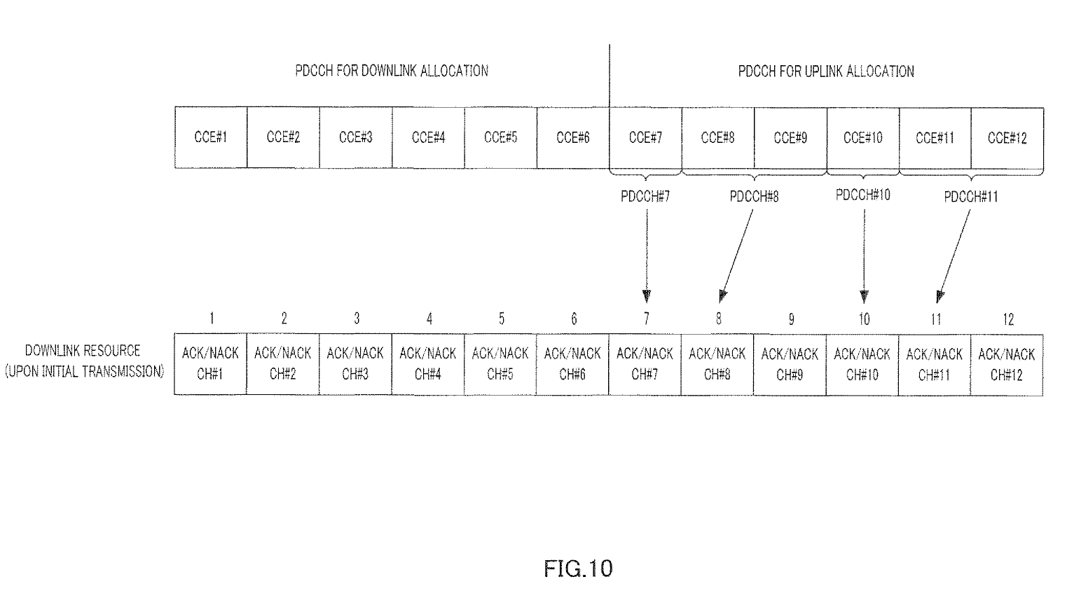

As shown in the upper part of FIG. 9 and the upper part of FIG. 10, as in Embodiment 1, twelve CCE's #1 to #12 will be used in the following explanation. Also, as shown in the lower part of FIG. 9 and the lower part of FIG. 10, as in Embodiment 1, a base station reserves in advance downlink resources 1 to 12 in which maximum twelve ACK/NACK channels CH #1 to CH #12 associated with twelve CCE's #1 to #12 are arranged. Also, as shown in the upper part of FIG. 9 and the upper part of FIG. 10, using six CCE's, two PDCCH's are each comprised of two CCE's, and two PDCCH's are each comprised of one CCE, as PDCCH's for uplink allocation.

First, an assignment of ACK/NACK channels in an HARQ frame of an HARQ frame number that is an odd number will be explained. In an HARQ frame of an HARQ frame number that is an odd number, as shown in FIG. 9, PDCCH's for uplink allocation are used in ascending order form CCE #1 to CCE #6. Here, as shown in the upper part of FIG. 9, PDCCH's #1, #3, #4 and #6 for uplink allocation are comprised of six CCE's of CCE's #1 to #6. Therefore, as shown in FIG. 9, ACK/NACK channel allocating section 105 allocates a response signal to uplink data upon the first transmission (initial transmission), on a per PDCCH basis, to an ACK/NACK channel associated with the CCE of the lowest CCE number among a plurality of CCE's comprising a PDCCH. To be more specific, as shown in FIG. 9, ACK/NACK channel allocating section 105 allocates response signals to uplink data allocated by PDCCH's #1, #3, #4 and #6, to ACK/NACK channels CH #1, CH #3, CH #4 and CH #6, respectively.

Next, an assignment of ACK/NACK channels in an HARQ frame of an HARQ frame number that is an even number will be explained. In an HARQ frame of an HARQ frame number that is an even number, as shown in FIG. 10, PDCCH's for uplink allocation are used in descending order from CCE #12 to CCE #7. Here, as shown in the upper part of FIG. 10, PDCCH's #11, #10, #8 and #7 for uplink allocation are comprised of six CCE's of CCE's #12 to #7. Therefore, as shown in FIG. 10, ACK/NACK channel allocating section 105 allocates a response signal to uplink data upon the first transmission (initial transmission), on a per PDCCH basis, to an ACK/NACK channel associated with the CCE of the lowest CCE number among a plurality of CCE's comprising a PDCCH. To be more specific, as shown in FIG. 10, ACK/NACK channel allocating section 105 allocates response signals to uplink data allocated by PDCCH's #11, #10, #8 and #7 to ACK/NACK channels CH #11, CH #10, CH #8 and CH #7, respectively.

Also, if a second transmission (first retransmission) of uplink data is necessary, ACK/NACK channel allocating section 105 allocates a response signal to uplink data upon a second transmission (first retransmission), to the same ACK/NACK channel as an ACK/NACK channel assigned upon the first transmission (initial transmission). For example, as shown in FIG. 9, ACK/NACK channel allocating section 105 allocates response signals to uplink data upon a second transmission (first retransmission) in an HARQ frame of an HARQ frame number that is an even number, to same ACK/NACK channels CH #1, CH #3, CH #4 and CH #6 as ACK/NACK channels assigned upon the first transmission (initial transmission) in an HARQ frame of an HARQ frame number that is an odd number.

Also, taking into account avoidance of collision with an ACK/NACK channel to which a response signal to uplink data upon a second transmission (first retransmission) is allocated, a base station assigns a PDCCH for another mobile station.

As shown in FIG. 9 and FIG. 10, CCE's in which PDCCH's for uplink allocation and PDCCH's for downlink allocation are arranged, are switched per HARQ frame, For example, in an HARQ frame of an HARQ frame number that is an even number, a response signal upon a second transmission (first retransmission) is allocated to one of ACK/NACK channels CH #1 to CH #6 associated with CCE's assigned as PDCCH's for uplink allocation according to FIG. 9, that is, associated with CCE's of lower channel numbers (i.e. CCE's #1 to #6 shown in FIG. 9). By contrast with this, in an HARQ frame of an HARQ frame number that is an even number, a response signal upon the first transmission (initial transmission) is allocated to one of ACK/NACK channels CH #12 to CH #7 associated with CCE's assigned as PDCCH's for uplink allocation according to FIG. 10, that is, associated with CCE's of higher channel numbers (i.e. CCE's #12 to #7 shown in FIG. 10).

Also, in an HARQ frame of an HARQ frame number that is an odd number, PDCCH's for uplink allocation are assigned in ascending order from the CCE of the lowest CCE number. Therefore, in an HARQ frame of an HARQ frame number that is an even number, a response signal upon a second transmission (first retransmission) is more likely to allocate to an ACK/NACK channel of a lower channel number. By contrast, in an HARQ frame of an HARQ frame number that is an even number, CCE's are assigned as PDCCH's for uplink allocation in descending order from the CCE of the highest CCE number. Therefore, in an HARQ frame of an HARQ frame number that is an even number, a response signal upon the first transmission (initial transmission) is more likely to allocate to an ACK/NACK channel of a higher channel number. That is, as in Embodiment 4, an ACK/NACK channel to which a response signal upon a second transmission (first retransmission) is allocated is less likely to be equal to an ACK/NACK channel to which a response signal upon the first transmission (initial transmission) is allocated. Therefore, as in Embodiment 4, in an HARQ frame of an HARQ frame number that is an even number, although the base station allocates CCE's comprising a PDCCH for another mobile station with consideration of avoidance of collision with an ACK/NACK channel to which a response signal upon a second transmission (first retransmission) is allocated, a use of CCE's is not restricted in most cases. Also, the same applies to an HARQ frame of an HARQ frame number that is an odd number.

Thus, according to the present embodiment, CCE's are assigned as PDCCH's for uplink allocation in ascending order from the CCE of the lowest CCE number in the case of an HARQ frame of an HARQ frame number that is an odd number, and CCE's are assigned as PDCCH's for uplink allocation in descending order from the CCE of the highest CCE number in the case of an HARQ frame of an HARQ frame number that is an even number. By this means, even when the ACK/NACK channel of the lowest channel number (ACK/NACK channel CH #1 shown in FIG. 9) is used upon a second transmission (initial transmission), it is possible to assign the CCE of the lowest CCE number associated with that ACK/NACK channel, as a PDCCH for downlink allocation in the next HARQ frame. Therefore, it is possible to prevent unavailability of the CCE of the lowest CCE number. Therefore, according to the present embodiment, it is possible to prevent unavailability of the CCE of the lowest CCE number, and, as in Embodiment 1, improve data transmission efficiency.

Further, according to the present embodiment, for example, in an HARQ frame of an HARQ frame number that is an odd number, an ACK/NACK channel of a lower channel number associated with a CCE that is used more frequently as a PDCCH for uplink allocation (i.e. a CCE of a lower CCE number), is used more frequently. Further, in an HARQ frame of an HARQ frame number that is an even number in which a second transmission (first retransmission) for a mobile station is performed using that ACK/NACK channel, a response signal to uplink data upon the first transmission (initial transmission) for another mobile station, uses an ACK/NACK channel of a higher channel number associated with a CCE of a higher CCE number. By this means, in an HARQ frame of an HARQ frame number that is an even number, when a base station assigns a PDCCH for uplink allocation to another mobile station, CCE use restriction for avoiding collision with an ACK/NACK channel upon a second transmission (first retransmission) decreases. Therefore, according to the present embodiment, CCE use efficiency in the base station improves. Also, the same applies to an HARQ frame of an HARQ frame number that is an odd number.

Also, if a third transmission (i.e. second retransmission) is necessary, a use of CCE's for another mobile station is restricted to avoid collision between an ACK/NACK channel, to which a response signal upon a third transmission (i.e. second retransmission) is allocated, and an ACK/NACK channel to which a response signal upon the first transmission (initial transmission) in another mobile station is allocated. However, there is a low probability that a third or subsequent transmission (i.e. second or subsequent retransmission) is necessary, so that the whole system is subject to little influence.

Also, according to the present embodiment, when the number of CCE's used as a plurality of PDCCH's for uplink allocation is equal to or more than seven, the channel number of an ACK/NACK channel, to which a response signal to uplink data upon a second transmission (first retransmission) in a mobile station which is indicated by a CCE of a CCE number equal to or greater than seven, is allocated, is equal to or less than six. Consequently, there is a probability of collision with an ACK/NACK channel to which a response signal to uplink data upon the first transmission (initial transmission) for another mobile station is allocated. Therefore, a use of CCE's for another mobile station is restricted to avoid collision in that ACK/NACK channel. However, a case is rare where the number of CCE's used by a plurality of PDCCH's for uplink allocation requires seven or more, that is, where a half or more of the total number of CCE's are required, so that the whole system is subject to little influence,

Embodiments of the present invention have been described above.

Also, although cases have been described above with embodiments where a response signal to uplink data is transmitted, it is equally possible to apply the present invention to a response signal to downlink data. For example, a mobile station performs the same processing as in above base station 100, so that it is possible to apply the present invention to a response signal to downlink data. Here, a base station performs downlink resource allocation. That is, the mobile station does not perform the same processing as in PDCCH allocating section 101 in above base station 100. Therefore, the mobile station transmits a response signal using an ACK/NACK channel associated with a CCE used by an uplink control channel for requesting downlink data allocation. Alternatively, the mobile station transmits a response signal using an ACK/NACK channel associated with a CCE used by a downlink control channel for indicating downlink data allocation.

Also, a PDCCH used in explanation in the above embodiments may be referred to as an “SCCH (Shared Control CHannel),” “L1/L2 control channel,” “UL grant channel” or “CCCH (Common Control CHannel).” Also, an ACK/NACK channel may be referred to as a “PHICH” (Physical Hybrid ARQ Indicator CHannel) or “HICH” (Hybrid ARQ Indicator CHannel).

Also, a mobile station may be referred to as a “UE,” and a base station may be referred to as a “Node B.”

Also, the error detection method is not limited to CRC detection.

Although a case has been described above with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosures of Japanese Patent Application No. 2007-211103, filed on Aug. 13, 2007, and Japanese Patent Application No. 2007-285601, filed on Nov. 1, 2007, including the specifications, drawings and abstracts, are incorporated herein by reference in their entireties.

### INDUSTRIAL APPLICABILITY

The present invention is applicable to, for example, a mobile communication system.

1. A radio communication base station apparatus comprising:
a first allocating section that allocates resource allocation information of uplink data to a first control channel comprised of one or a plurality of control channel elements; and
a second allocating section that, upon an initial transmission or a second transmission of the uplink data, allocates a response signal to the uplink data to a second control channel associated with a control channel element different from a control channel element of a lowest control channel element number among the plurality of control channel elements.

2. The radio communication base station apparatus according to claim 1, wherein, when the first control channel is comprised of a plurality of control channel elements, the second allocating section allocates the response signal to a second control channel associated with a control channel element of a highest control channel element number among the plurality of control channel elements.

3. The radio communication base station apparatus according to claim 1, wherein, when the first control channel is comprised of a plurality of control channel elements, the second allocating section allocates the response signal to a second control channel associated with one of control channel elements other than the control channel element of the lowest control channel element number and a control channel element of a highest control channel element number, among the plurality of control channel elements.

4. The radio communication base station apparatus according to claim 1, wherein the second allocating section allocates the response signal to a second control channel shifted by a number of transmissions in ascending order from a second control channel used upon an initial transmission.

5. A channel allocating method comprising, upon an initial transmission or a second transmission of uplink data, allocating a response signal to the uplink data allocated according to resource allocation information allocated to a first control channel, to a second control channel associated with a control channel clement different from a control channel element of a lowest control channel element number among a plurality of control channel elements.
